(19) United States
(12) Patent Application Publication
(10) Pub. No.: US 2017/0252721 A1
(43) Pub. Date: Sep. 7, 2017

(54) TRANSFORMER OIL MOISTURE REMOVING APPARATUS

(71) Applicant: Virginia Transformer Corporation, Roanoke, VA (US)

(72) Inventor: Prabhat K. JAIN, Roanoke, VA (US)

(73) Assignee: Virginia Transformer Corporation, Roanoke, VA (US)

(21) Appl. No.: 15/062,428

(22) Filed: Mar. 7, 2016

(51) Int. Cl. B01J 20/28; H01F 27/24

(52) U.S. Cl. CPC B01J 20/28033; H01F 27/24

(57) ABSTRACT

A transformer oil moisture removing apparatus and fabric may he provided. At least one piece of the fabric may be inserted in a transformer such that it is in contact with the transformer oil. The fabric may chemically interact with the oil to remove water and moisture. The fabric may not affect the electrical insulation and cooling properties of the transformer oil. The fabric may be in a transformer for the duration of the transformer's life.

### BACKGROUND

Transformer oil works as an electrical insulation and also as a cooling medium. The life of a transformer depends very highly on the dryness of its electrical insulation, which in turn depends on the properties of the transformer oil. The electrical insulating properties of transformer oil depend on the amount of moisture present in the oil. Less moisture results in better insulating property. Moisture in oil can come from various sources, including solid insulations of cellulosic nature.

### SUMMARY

According to an exemplary embodiment, a transformer oil moisture removing fabric may be provided. A transformer oil moisture removing fabric may include organic and inorganic material. The fabric may he configured to he disposed inside a transformer, such that it contacts transformer oil. The fabric may further be configured to chemically interact with moisture in the transformer oil without affecting the chemical properties of the transformer oil.

According to another exemplary embodiment, a transformer oil moisture removing apparatus may be provided. The transformer oil moisture removing apparatus may include a transformer, which may include a tank filled with transformer oil. The transformer oil may be an electrical insulation and cooling medium. There may he a transformer coil and transformer core disposed within the tank. The apparatus may further include at least one piece of fabric, which may chemically interact with moisture in the transformer oil, but not affect the insulation and cooling properties of the transformer oil. The fabric may be inserted in the transformer oil.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 may show an exemplary transformer oil moisture removal apparatus.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

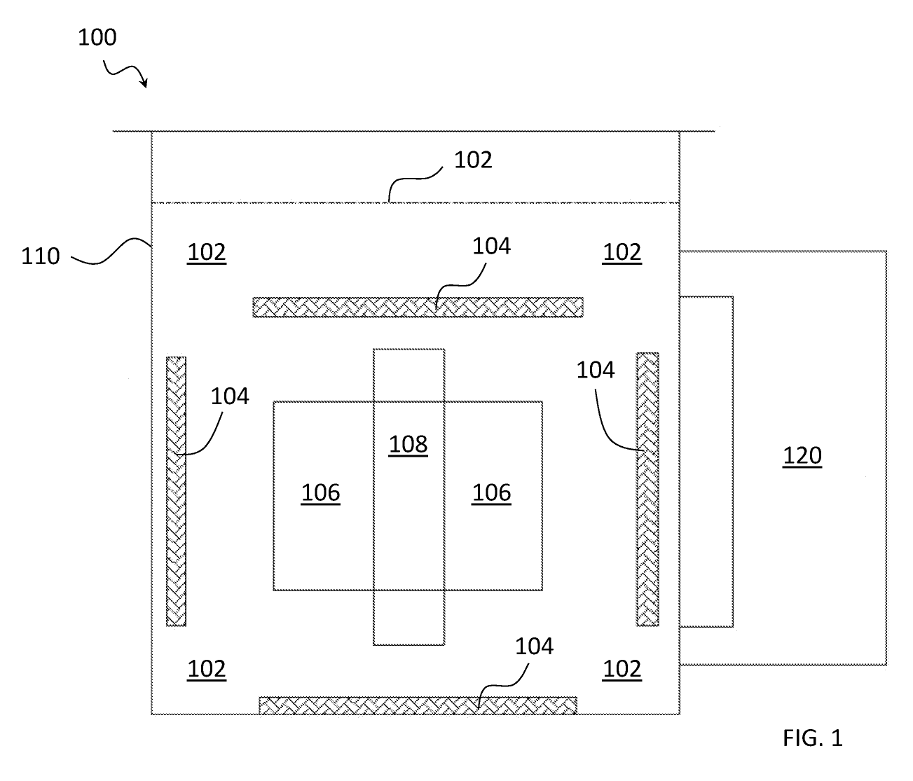

According to an exemplary embodiment, as shown in FIG. 1, a piece of fabric or mat 104 may be placed in a transformer 100, such that it is in direct contact with the transformer oil. An exemplary transformer 100 may include a tank 110 and a radiator 120. A transformer tank 110 may be filled with transformer oil 102 and may have a transformer coil 106 and transformer core 108 disposed therein. The piece of fabric or mat 104 may contain organic and inorganic materials and may absorb or adsorb moisture in suspension and molecular water within transformer oil 102. The fabric or mat 104 may chemically interact with the moisture and in some embodiments may change into a different material due to the chemical interaction. By capturing and removing moisture from the transformer oil 102, the oil's electrical insulating properties may be maintained. This may, in turn, improve the functioning and prolong the life of the transformer 100.

In an exemplary embodiment, the fabric or mat 104 may optionally be placed in at the bottom of the transformer 100. In alternative exemplary embodiments, fabric or mat 104 may be placed in any desired location within a transformer tank 110, such that it contacts oil 102. In yet further exemplary embodiments, multiple pieces of fabric or mats 104 may be placed in a transformer tank 110. Fabric or mats 104 may be placed around a transformer coil 106 and transformer core 108.

The oil 102 in an exemplary transformer 100 may continuously move or circulate due to natural convection current or due to forced circulation. In some embodiments, the transformer oil 102 may circulate a slow speed. The movement of the transformer oil 102 may increase the amount of oil 102 contacting the fabric 104, further improving the moisture removing ability. In some exemplary embodiments, the fabric or mat 104 may optionally be secured within the transformer 100 such that it does not move around.

The fabric 104 and any products of chemical interactions between the fabric 104 and moisture or the transformer oil 102, itself, may be compatible with the transformer oil 102 and may not degrade its properties, such as but not limited to its insulating properties. The fabric 104 may be shaped and sized to maximize effectiveness in a given transformer 100. This may include being shaped and sized to maximize surface area for contact with the transformer oil 102, and it may entail being capable of capturing moisture present or generated throughout the lifetime of a given transformer 100. The size of the transformer 100 and its oil quantity may be accounted for in the sizing of the fabric 104. Sizing the fabric 104 to remove moisture for the life of a transformer 100 may allow the fabric 104 to he left inside the transformer 100 for the duration of its life, maintenance-free.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should he regarded as illustrative rather than restrictive. Accordingly, it should be appreciated that variations to those embodiments can be made by those skilled in the art without departing from the scope of the invention as defined by the following claims.

What is claimed is:

1. A transformer oil moisture removing fabric comprising:
a fabric made of organic and inorganic material;
wherein the fabric is configured to be disposed inside a transformer, such that it is in contact with transformer oil; and
wherein the fabric is configured to chemically interact with moisture in transformer oil without affecting the chemical properties of the transformer oil.

2. The transformer oil moisture removing apparatus of claim 1, wherein the fabric is affixed to the interior of a transformer.

3. The transformer oil moisture removing apparatus of claim 1, wherein the fabric removes moisture from the transformer oil by absorption or adsorption.

4. The transformer oil moisture removing apparatus of claim 1, wherein byproducts created by the chemical interaction do not affect the chemical properties of the transformer oil.

5. A transformer oil moisture removing apparatus comprising:
a transformer, the transformer comprising a tank filled with transformer oil configured to function as an electrical insulation and cooling medium;
a transformer coil and transformer core disposed within the tank; and
at least one piece of fabric configured to chemically interact with moisture in the transformer oil without affecting the insulation and cooling properties of the transformer oil, wherein the fabric is inserted in the transformer oil.

6. The transformer oil removing apparatus of claim 5, wherein the transformer oil is circulated within the transformer.

7. The transformer oil removing apparatus of claim 5, wherein the at least one piece of fabric is secured to the interior of the transformer tank to prevent movement.

8. The transformer oil removing apparatus of claim 5, wherein the at least one piece of fabric is configured to be left within the transformer for the lifetime of the transformer.

9. The transformer oil removing apparatus of claim 8, wherein the at least one piece of fabric is sized and shaped to continually capture moisture within a transformer for the lifetime of the transformer.

10. The transformer oil removing apparatus of claim 5, wherein the at least one piece of fabric removes moisture from the transformer oil by absorption or adsorption.
